(19) United States
(12) Patent Application Publication
(10) Pub. No.: US 2026/0370530 A1
(43) Pub. Date: Nov. 19, 2026

(54) DEVICES, METHODS AND APPARATUSES FOR SRS ENHANCEMENT

(71) Applicant: Nokia Technologies Oy, Espoo (FI)

(72) Inventors: Pasi Eino Tapio KINNUNEN, Oulu (FI); Juha Pekka KARJALAINEN, Oulu (FI); Youngsoo YUK, Seoul (KR); Petri LUOTO, Oulu (FI)

(21) Appl. No.: 19/103,186

(22) PCT Filed: Sep. 29, 2023
(86) PCT No.: PCT/IB2023/059813

§ 371 Date: Feb. 11, 2025

(30) Foreign Application Priority Data
Sep. 30, 2022 (GB) 2214442.2

(51) Int. Cl. H04L 27/26; H04J 13/00; H04L 5/00; H04W 72/0453

(52) U.S. Cl. CPC H04L 27/2613; H04J 13/004; H04L 5/0051; H04W 72/0453

(57) ABSTRACT

Embodiments of the present disclosure disclose devices, methods and apparatuses for SRS enhancements. A terminal device receives, from a network device, sounding reference signal, SRS, configuration information indicating one or more orthogonal cover code, OCC, sequences in frequency domain, wherein the one or more OCC sequences have a length of one or more of 3 or 6. The terminal device further transmits, to the network device, a SRS signal using an OCC sequence from the one or more OCC sequences.

### FIELD

Embodiments of the present disclosure generally relate to the field of communication, and in particular, to devices, methods, apparatuses and computer readable storage medium for sounding reference signal (SRS) enhancement.

### BACKGROUND

In the third generation partnership project (3GPP) release 18 (Rel-18), one of multiple input multiple output (MIMO) topics is to define additional uplink (UL) SRS antenna ports. It has been proposed to increase number of UL SRS antenna ports without increasing the number of base sequences for SRS. Extension of the number of cyclic shifts was proposed for SRS transmission comb-8.

However, when increasing the number of cyclic shifts, channel estimation quality may degrade in the presence of a long delay spread. Therefore, there is a limited space for increasing number of cyclic shifts for any of comb patterns. Therefore, to support more UL SRS antenna ports, there is a need for improved solutions for SRS enhancement.

### SUMMARY

In general, example embodiments of the present disclosure provide devices, methods, apparatuses and computer readable storage medium for SRS enhancement.

In a first aspect, there is provided a terminal device. The terminal device may comprise one or more transceivers; and one or more processors communicatively coupled to the one or more transceivers, and the one or more processors are configured to cause the terminal device to: receive, from a network device, sounding reference signal, SRS, configuration information indicating one or more orthogonal cover code, OCC, sequences in frequency domain, wherein the one or more OCC sequences have a length of one or more of 3 or 6; and transmit, to the network device, a SRS signal using an OCC sequence from the one or more OCC sequences.

In a second aspect, there is provided a network device. The network device may comprise one or more transceivers; and one or more processors communicatively coupled to the one or more transceivers, and the one or more processors are configured to cause the network device to: transmit, to a terminal device, sounding reference signal, SRS, configuration information indicating one or more orthogonal cover code, OCC, sequences in frequency domain, wherein the one or more OCC sequences have a length of one or more of 3 or 6; and receive, from the terminal device, a SRS signal using an OCC sequence from the one or more OCC sequences.

In a third aspect, there is provided a method implemented at a terminal device. The method may comprise: receiving, from a network device, sounding reference signal, SRS, configuration information indicating one or more orthogonal cover code, OCC, sequences in frequency domain, wherein the one or more OCC sequences have a length of one or more of 3 or 6; and transmitting, to the network device, a SRS signal using an OCC sequence from the one or more OCC sequences.

In a fourth aspect, there is provided a method implemented at a network device. The method may comprise: transmitting, to a terminal device, sounding reference signal, SRS, configuration information indicating one or more orthogonal cover code, OCC, sequences in frequency domain, wherein the one or more OCC sequences have a length of one or more of 3 or 6; and receiving, from the terminal device, a SRS signal using an OCC sequence from the one or more OCC sequences.

In a fifth aspect, there is provided an apparatus of a terminal device. The apparatus may comprise: means for receiving, from a network device, sounding reference signal, SRS, configuration information indicating one or more orthogonal cover code, OCC, sequences in frequency domain, wherein the one or more OCC sequences have a length of one or more of 3 or 6; and transmitting, to the network device, a SRS signal using an OCC sequence from the one or more OCC sequences.

In a sixth aspect, there is provided an apparatus of a network device. The apparatus may comprise: means for transmitting, to a terminal device, sounding reference signal, SRS, configuration information indicating one or more orthogonal cover code, OCC, sequences in frequency domain, wherein the one or more OCC sequence have a length of one or more of 3 or 6; and means for receiving, from the terminal device, a SRS signal using an OCC sequence from the one or more OCC sequences.

In a seventh aspect, there is provided a terminal device. The terminal device may comprise at least one processor; and at least one memory including computer program codes, wherein the at least one memory and the computer program codes are configured to, with the at least one processor, cause the terminal device to: receive, from a network device, sounding reference signal, SRS, configuration information indicating one or more orthogonal cover code, OCC, sequences in frequency domain, wherein the one or more OCC sequences have a length of one or more of 3 or 6; and transmit, to the network device, a SRS signal using an OCC sequence from the one or more OCC sequences.

In an eighth aspect, there is provided a network device. The network device may comprise at least one processor; and at least one memory including computer program codes, wherein the at least one memory and the computer program codes are configured to, with the at least one processor, cause the network device to: transmit, to a terminal device, sounding reference signal, SRS, configuration information indicating one or more orthogonal cover code, OCC, sequences in frequency domain, wherein the one or more OCC sequences have a length of one or more of 3 or 6; and receive, from the terminal device, a SRS signal using an OCC sequence from the one or more OCC sequences.

In a ninth aspect, there is provided a non-transitory computer readable medium comprising program instructions for causing an apparatus to perform at least the method according to third or fourth aspect.

In a tenth aspect, there is provided a computer program comprising instructions, which, when executed by an apparatus, cause the apparatus at least to: receive, from a network device, sounding reference signal, SRS, configuration information indicating one or more orthogonal cover code, OCC, sequences in frequency domain, wherein the one or more OCC sequences have a length of one or more of 3 or 6; and transmit, to the network device, a SRS signal using an OCC sequence from the one or more OCC sequences.

In an eleventh aspect, there is provided a computer program comprising instructions, which, when executed by an apparatus, cause the apparatus at least to: transmit, to a terminal device, sounding reference signal, SRS, configuration information indicating one or more orthogonal cover code, OCC, sequences in frequency domain, wherein the one or more OCC sequences have a length of one or more of 3 or 6; and receive, from the terminal device, a SRS signal using an OCC sequence from the one or more OCC sequences.

In a twelfth aspect, there is provided a terminal device. The terminal device may comprise receiving circuitry configured to receive, from a network device, sounding reference signal, SRS, configuration information indicating one or more orthogonal cover code, OCC, sequences in frequency domain, wherein the one or more OCC sequences have a length of one or more of 3 or 6; and transmitting circuitry configured to transmit, to the network device, a SRS signal using an OCC sequence from the one or more OCC sequences.

In a thirteenth aspect, there is provided a network device. The network device may comprise transmitting circuitry configured to transmit, to a terminal device, sounding reference signal, SRS, configuration information indicating one or more orthogonal cover code, OCC, sequences in frequency domain, wherein the one or more OCC sequences have a length of one or more of 3 or 6; and receiving circuitry configured to receive, from the terminal device, a SRS signal using an OCC sequence from the one or more OCC sequences.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates an example flowchart of a method implemented at a terminal device according to example embodiments of the present disclosure;

FIG. 3 illustrates an example flowchart of a method implemented at a network device according to example embodiments of the present disclosure;

FIG. 4 illustrates an example signaling process for SRS enhancement according to some embodiments of the present disclosure;

FIG. 5A illustrates example correlations of baseline SRS sequences for 306 resource length of allocation;

FIG. 5B illustrates example correlations of SRS sequences with OCC for 306 resource length of allocation;

FIG. 6A illustrates example cubic metric (CM) for SRS symbol in comparison of prior art configuration and proposed OCC sequences;

FIG. 6B illustrates example peak average power ratio (PAPR) for SRS symbol in comparison of prior art configuration and proposed OCC sequences;

FIG. 7 illustrates an example simplified block diagram of a device that is suitable for implementing embodiments of the present disclosure; and

FIG. 8 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a New Radio (NR) NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The 3GPP MIMO topic targets for SRS enhancement and it was already proposed to study or specify SRS enhancements to enable 8TX ULoperation to support 4 or more layers per UE in UL targeting for customer premises equipment (CPE)/fixed wireless access (FWA)/vehicle/industrial devices.

In 3GPP specification 38.331 (-h10 Jun. 2022), SRS resource set is configured where “srs-ResourceIdList” defines SRS resource list, “resourceType defines triggering mechanism (aperiodic, semi-persistent, periodic)”, and “usage” is for configuration reason (beamManagement, codebook, nonCodebook antennaSwitching). SRS resource are also configured, where “nrofSRS-Ports” defines 1, 2, or 4 ports, “transmissionComb” is used to define comb 2 and 4 with specific cyclic shift, “transmissionComb-n8-r17” is used to define comb 8, “frequencyHopping” provides configuration information related to frequency hopping, “groupOrSequenceHopping” defines if grouping is defined for SRS allocation, and “resourceType” defines periodicity of allocation.

As mentioned above, in 3GPP Rel-18, one of MIMO topics is to define additional UL SRS antenna ports. Since the number of the base sequences may be limited and meanwhile increasing number of cyclic shifts for SRS comb patterns might cause channel estimation quality degradation, TD OCC for code division multiplexing may be applied to increase SRS antenna ports. Typically, TD OCC sequences have a length of 2 or 4. However, it causes problems such as increased detection time of SRS antenna ports, repetition of UL SRS symbol over length of OCC, and etc. In view of the above, for supporting more SRS antenna ports by SRS, there is a need for improved solutions for SRS enhancement.

According to embodiments of the present disclosure, there is provided a scheme for SRS enhancement. With this scheme, a terminal device receives, from a network device, sounding reference signal, SRS, configuration information. The SRS configuration information may indicate one or more orthogonal cover code, OCC, sequences in frequency domain. The one or more OCC sequences may have a length of one or more of 3 or 6. Moreover, the terminal device may transmit, to the network device, a SRS signal using an OCC sequence from the one or more OCC sequences.

By means of this antenna port configuration information, this scheme may use FD OCC having a length of 3 or 6 for supporting more SRS antenna ports. For example, for the OCC having the length of 6 with the comb size of 2, the number of supported antenna ports will be increased by a factor of 6. In addition, it may also enable the increase of SRS antenna port with a better performance.

To support more SRS antenna port, it was already proposed to use time domain (TD) OCC having a length of OCC lengths of 2 or 4. However, the drawback lies in that detection time of SRS antenna port will be increased by delay of SRS transmission over the OCC sequence. Moreover, it requires a repetition of UL SRS symbol over the length of TD OCC. Furthermore, it creates a scheduling restriction for the network. However, in the present disclosure, the OCC sequence is in frequency domain, it will not bring any increase in detection time of SRS antenna port. Meanwhile, it does not need repetition of UL SRS symbols over the length of TD OCC, and thus it will not cause scheduling restriction for the network, either.

Besides, the FD OCC sequences with lengths of 3 and/or 6 are longer than traditional OCC sequences. Therefore, compared with traditional OCC sequences with the length 2 or 4, the proposed OCC sequences may enable to add more resources into given resources, in this case more antenna ports. In addition, the OCC sequences having the length of 3 may give one additional ports when compared to OCC sequences having a length of 2, and the OCC sequences having a length of 6 gives 2 additional ports compared to OCC sequences having a length of 4.

In addition, the length of 6 may fit better into SRS comb size of 2, since there are already 6 resource elements per physical resource block (PRB). The length of 4 fails to support these 6 resources since the number of resource element of SRS transmission per PRB is not a multiple of 4. Moreover, only OCC can be fitted on 2 resource elements (REs), i.e., 4 ports less than with OCC sequences with the length of 4 supported.

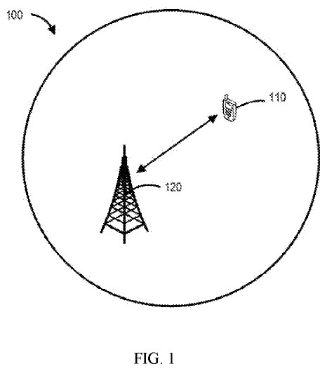

Hereinafter, principle and embodiments of the present disclosure will be described in detail below with reference to the accompanying drawings. Reference is first made to FIG. 1, which illustrates an example environment 100 in which example embodiments of the present disclosure can be implemented.

The environment 100, which may be a part of a communication network, comprises a terminal device 110 and a network device 120 communicating with each other or with other devices via each other. The communication environment 100 may comprise any suitable number of devices and cells. In the communication environment 100, the terminal device 110 and the network device 120 can communicate data and control information with each other. A link from the network device 120 to the terminal device 110 is referred to as a downlink (DL), while a link from the terminal device 110 to the network device 120 is referred to as an uplink (UL).

It is to be understood that two devices are shown in the environment 100 only for the purpose of illustration, without suggesting any limitation to the scope of the present disclosure. In some example embodiments, the environment 100 may comprise a further device to communicate with the terminal device 110 and network device 120.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connectivity (DC), and New Radio Unlicensed (NR-U) technologies.

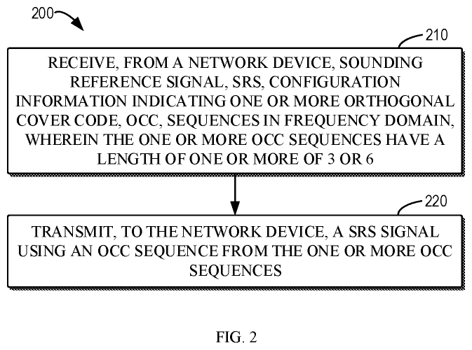

FIG. 2 illustrates an example flowchart of a method 200 implemented at a terminal device according to example embodiments of the present disclosure. For the purpose of discussion, the method 200 will be described from the perspective of the terminal device 110 with reference to FIG. 1.

As shown in FIG. 2, at block 210, the terminal device 110 may receive, from a network device 120, sounding reference signal, SRS, configuration information indicating one or more orthogonal cover code, OCC, sequences in frequency domain. The one or more OCC sequences may have a length of one or more of 3 or 6.

At block 220, the terminal device 110 may transmit, to the network device 120, a SRS signal using an OCC sequence from the one or more OCC sequences.

In some example embodiments, the SRS configuration information comprises one or more of length information of the one or more OCC sequences and OCC sequence starting information for the one or more OCC sequences. For example, the length information of the one or more OCC sequences and the OCC sequence starting information may be signaled together or separately from the network device 112 to the terminal device 110.

In some example embodiments, the SRS configuration information is comprised in a field in an SRS resource list. This filed could a new filed in the SRS resource list. For example, the SRS configuration information may be included in a new filed under SRS resource list as below.

```
fdOcc-r18 SEQUENCE {
  occLength-r18 INTEGER (0..3), // 0=3, 1=6, 2=12 length of OCC
  occStartingIndex-r18 INTEGER (0...15), // OCC index
  }
```

where occLength-r18 may be 2 bits and denote the length of OCC sequences, and occStartingIndex-r18 may be 4 bits and denote the starting index of the OCC sequence information.

In some example embodiments, the SRS configuration information may comprise offset information on the one or more OCC sequences for a group of antenna ports. The terminal device 110 may determine an OCC sequence from the one or more OCC sequences based on the offset information for the group of antenna ports. The offset information may also be included in a new field under SRS-Resource list. Fox example, the offset information may be defined as follows:
occOffset-n6-r18 INTEGER (0 . . . 5).

This parameter may indicate an offset of allocated antenna ports for e.g. the OCC length of 6. Similar parameter may be defined for the OCC length of 3. As an example for the OCC length of 6, if 4 antenna ports are allocated with occOffset-n6-r18=2, the terminal device may use indexes 2+x, where x is e.g.
if allocated to comb 2: x={0, 1} for RE offset 0 (two antenna ports per comb); and x={0, 1} for RE offset 1 (similar to RE offset 0).

In some embodiments, the offset information (e.g. occOffset-n6-r18) may be configured to a group of terminal devices for e.g. joint transmission purposes over multiple transmitters. By reserving specific offset(s) for this type of usage, OCC can be used for allocating specific resources for the group of terminal device.

In some example embodiments, the terminal device may determine an index of an OCC sequence from the one or more OCC sequences. The index may be rotated based on one or more of an index of a timeslot for transmission of the SRS signal or identity of a cell (Cell ID). The term “rotated” or “rotation” refers to an operation of reordering indexes. For example, for indexes 1, 2, 3 and 4, after rotation, the resulting indexes will be indexes 4, 3, 2, and 1.

For example, the rotated index “occIndex” may be determined based on an equation as below.

occIndex=mod(occOffset-n6-r18+slotIndex,occ sequence length)

where the parameter “occOffset-n6-r18” denotes the above mentioned offset information, the parameter “slotIndex” denotes the index of timeslot, and the parameter “occ sequence length” denotes the length of OCC sequences, which may be 3 or 6.

In some example embodiments, the length of the OCC sequence may be determined based on the size of SRS transmission comb for the terminal device. For example, rel18 SRS is signalled for the terminal device 110 by the network device 120 (e.g. gNB) in the SRS configuration information. The length of OCC sequences may be selected based on configured SRS comb size. The size of SRS transmission comb may indicate a density of subcarriers occupied by resource elements for the SRS sequence.

In some example embodiments, the length of the OCC sequence may be determined as 6 when a size of SRS transmission comb is 2. In this case, the OCC sequences cover one PRB. In some example embodiments, the length of the OCC sequence may be determined as 3 when a size of SRS transmission comb is 4. In this case the OCC sequences cover one PRB. In some example embodiments, the length of the OCC sequence may be determined as 3 when a size of SRS transmission comb is 8. In this case, the OCC sequences cover two PRBs.

Example scheme of OCC sequence length selection may be provided as follows only for illustrative purposes:
comb 2: OCC length of 6 (covering one PRB)
comb 4: OCC length of 3 (covering one PRB)
comb 8: OCC length of 3 (covering two PRBs, currently comb 8 is not used for SRS channel measurements and is used for positioning measurements only).

It can be seen that number of ports can be increased up to 12 antenna ports by extending OCC over two adjacent PRBs starting from first allocated PRB. It may be advantageous that if eight antenna ports are only needed, and the remaining 4 antenna ports (any subset of given OCC sequences) may be reserved for future use.

In some embodiments, the elements of the one or more OCC sequences may have a unit amplitude. In some embodiments, the one or more OCC sequence may be multiplied with any scalar value, which will not change properties of the OCC sequences.

In some example embodiments, the one or more OCC sequences with the length of 6 may comprise one or more of:
a first sequence of [1, 1, 1, 1, 1, 1];
a second sequence of [x1, x2, x3, x4, x5, x6], wherein x1, x2, x3, x4, x5, and x6 denote six complex numbers corresponding to six points equally dividing a circumference of a unit circle;
a third sequence of [x6, x5, x4, x3, x2, x1];
a fourth sequence obtained by multiplying [x2, x3, x4, x5, x6, x1] with [1, −1, 1, −1, 1, −1];
a fifth sequence of an inversed version of the fourth sequence; and
a sixth sequence of [x −x, x, −x, x, −x], where x denotes a complex number at a unit circle.

For sequences of length 6, the first sequence is an all-one sequence and may be regarded as a baseline sequence. The baseline sequence may be used for detecting and/or enabling multiplexing of legacy UL SRS with Rel-18 UL SRS. The sixth sequence may be [1 −1, 1, −1, 1, −1], i.e., x=1.

The second sequence may be for example, Exp(j*(2/6)*pi*i), i=0, 1 . . . 5, where j denotes imaginary unit. Note that the third, the forth, and the fifth sequences may be derived from the second one. For example, the third sequence may be an inverse version of the second sequence. For another example. The fourth sequence may be obtained by multiplying a shifted version (cyclic shifted to left by 1) of the second sequence with a predetermined sequence, for example, [1, −1, 1, −1, 1, −1].

In some example embodiments, the one or more OCC sequences with the length of 3 may be derived from the above six OCC sequences of the length of 6, for example, the first three elements from three of the six OCC sequences.

In some embodiments, the one or more OCC sequences with the length of 3 may comprise one or more of:
a first sequence of [1, 1, 1];
a second sequence obtained by multiplying [x1, x2, x3], wherein each of x1, x2, and x3 denotes three complex numbers corresponding to three of six points equally dividing a circumference of a unit circle; and
a third sequence of [x3, x2, x1].

Here, the second sequence of length 3 may be, for example, Exp(j*(2/6)*pi*i), i=1, 3, 5.

As mentioned, with the proposed FD OCC here, the number of antenna ports can be extended substantially. For example, for the SRS comb size of 2, there exist two resource sets per PRB. Both of the sets with the length of 6 resource elements (REs) can be used with length of 6 OCC sequence and therefore the number of antenna ports can be extended by factor of 6. This may result 2*4*6=48 antenna ports per PRB and per base sequence. A preferable way to map e.g. 8 antenna ports for these resources is to allocate 4 antenna ports per comb set as below.
Comb set with RE offset 0, include antenna ports 1000 to 1003, and Comb set with RE offset 1 include antenna ports 1004 to 1007, or.
Comb set with RE offset 0, include antenna ports 1000, 1002, 1004 and 1006, and Comb set with RE offset 1 include antenna ports 1001, 1003, 1005 and 1007.

Thus, with this solution proposed herein, the number of antenna ports may be increased by 6 times at maximum. Also, as already mentioned above, the detection time of the OCC sequence is not increased (interference is increased as expected like with any multi sequence transmission towards sequences which are non-orthogonal at SRS reception/detection time). For the length of 3 OCC code similar advantages can be seen.

Further, it should be noted that the SRS interference might increase in SRS detection due to additional SRS antenna ports. As an example, the legacy solution has 30*8*2 sequences for comb 2, now it is possible to have 30*8*2*6 sequences according to proposed solution. Additional transmitting ports may be allocated with utilizing channel information for given environment, which may increase the cell capacity. Therefore, despite the increase of SRS interference, overall throughput will be increased due to increased measurement capacity for SRS antenna ports.

Same sequence definition of OCC length 6 and/or 3 may be used for DL or UL DMRS purposes. For UL receiver implementation can utilize same knowledge of allocated new SRS sequences to detect previous versions of SRS sequences when allocated into same resources in time and frequency (referring to previously mentioned OCC removal and detection of previous versions of SRS sequences).

In some embodiments, the OCC sequence length or OCC sequence offset can be indicated to UE dynamically with DCI (e.g. format 1_0, format 1_1, etc.) configuration together with DMRS configuration.

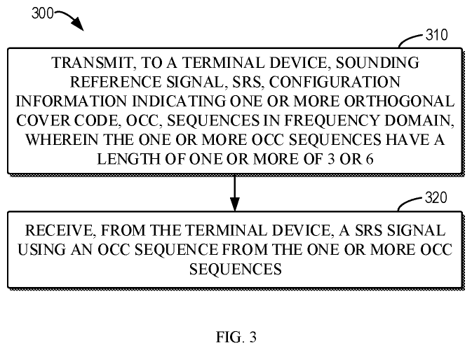

FIG. 3 illustrates an example flowchart of a method 300 implemented at a network device according to example embodiments of the present disclosure. For the purpose of discussion, the method 200 will be described from the perspective of the network device 120 with reference to FIGS. 1 and 2.

As shown in FIG. 3, at block 310, the network device 120 may transmit, to a terminal device 110, sounding reference signal, SRS, configuration information indicating one or more orthogonal cover code, OCC, sequences in frequency domain The one or more OCC sequences may have a length of one or more of 3 or 6.

At block 320, the network device 120 may receive, from the terminal device 110, a SRS signal using an OCC sequence from the one or more OCC sequence.

In some example embodiments, the SRS configuration information may comprise one or more of length information of the one or more OCC sequences and OCC sequence starting information for the one or more OCC sequences. In some example embodiments, the SRS configuration information may be comprised in a field in an SRS resource list.

In some example embodiments, the SRS configuration information may comprise offset information on the one or more OCC sequences for a group of antenna ports, and wherein the OCC sequence from the one or more OCC sequences is determined based on the offset information for the group of antenna ports.

In some example embodiments, the one or more OCC sequences with the length of 6 may comprise one or more of:
a first sequence of [1, 1, 1, 1, 1, 1];
a second sequence of [x1, x2, x3, x4, x5, x6], wherein x1, x2, x3, x4, x5, and x6 denote six complex numbers corresponding to six points equally dividing a circumference of a unit circle;
a third sequence of [x6, x5, x4, x3, x2, x1];
a fourth sequence obtained by multiplying [x2, x3, x4, x5, x6, x1] with [1, −1, 1, −1, 1, −1];
a fifth sequence of an inversed version of the fourth sequence;
a sixth sequence of [x −x, x, −x, x, −x], where x denotes a complex number at a unit circle.

For sequences of length 6, the first sequence may be regarded as a baseline sequence which may be is used for detecting and/or enabling multiplexing of legacy UL SRS with Rel-18 UL SRS.

The network device 120 may use this baseline OCC sequence together with earlier release SRS sequence, then all signal sequences may be treated with OCC detection where resource elements covered with OCC are averaged (or summed up) to form single sample over OCC resources. Resulted sample can be used for SRS measurement and can be up-sampled according to an intended sampling rate (e.g. by a repeater, filter, i.e. a finite impulse response filter)

The second sequence may be for example Exp(j*(2/6)*pi*i), i=0, 1 . . . 5, where j denotes imaginary unit. Note that the third, the forth, and the fifth sequences may be derived from the second one.

In some example embodiments, the one or more OCC sequences with the length of 3 may comprise one or more of:
a first sequence of [1, 1, 1];
a second sequence obtained by multiplying [x1, x2, x3], wherein each of x1, x2, and x3 denotes three complex numbers corresponding to three of six points equally dividing a circumference of a unit circle; and
a third sequence of [x3, x2, x1]. Here, the second sequence of length 3 may be for example Exp(j*(2/6)*pi*i), i=1, 3, 5.

In some example embodiments, an index of the OCC sequence from the one or more OCC sequences is rotated based on one or more of an of a timeslot for transmission of the SRS signal or identity of a cell.

In some example embodiments, the length of the OCC sequence may be determined based on a size of SRS transmission comb for the terminal device. In some example embodiments, the size of SRS transmission comb may indicate a density of subcarriers occupied by resource elements for the SRS sequence.

In some example embodiments, the length of the OCC sequence may be determined as 6 when a size of SRS transmission comb is 2. In some example embodiments, the length of the OCC sequence may be determined as 3 when a size of SRS transmission comb is 4. In some example embodiments, the length of the OCC sequence may be determined as 3 when a size of SRS transmission comb is 8.

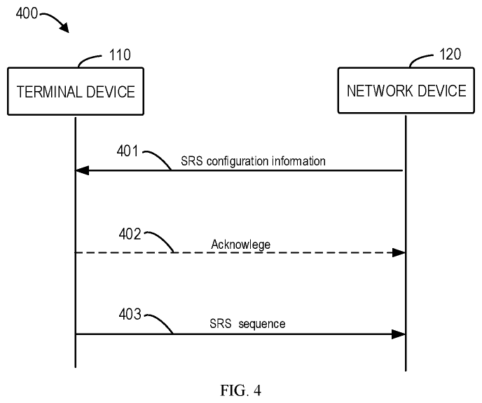

FIG. 4 illustrates an example signaling process for SRS enhancement according to some embodiments of the present disclosure. For the purpose of discussion, the process 400 will be described with reference to FIGS. 1 to 3. The process 400 may involve the terminal device 110 and network devices 120 as illustrated in FIG. 1. It would be appreciated that although the process 400 has been described in the communication environment 100 of FIG. 1, this process may be likewise applied to other communication scenarios with similar issues.

In the process 400, at 401, the terminal device 110 receives, from a network device, sounding reference signal, SRS, configuration information indicating one or more orthogonal cover code, OCC, sequences in frequency domain, wherein the one or more OCC sequences have a length of one or more of 3 or 6. In some embodiments, the SRS configuration information is comprised in a field in an SRS resource list.

The SRS configuration information may comprise one or more of length information of the one or more OCC sequences and OCC sequence starting information for the one or more OCC sequences. The SRS configuration information may further comprises offset information on the one or more OCC sequences for a group of antenna ports. The terminal device 110 may use the offset information for the group of antenna ports to determine a sequence from the one or more OCC sequences.

In some embodiments, the one or more OCC sequences with the length of 6 may comprise
a first sequence of [1, 1, 1, 1, 1, 1],
a second sequence of [x1, x2, x3, x4, x5, x6], wherein x1, x2, x3, x4, x5, and x6 denote six complex numbers corresponding to six points equally dividing a circumference of a unit circle,
a third sequence of [x6, x5, x4, x3, x2, x1],
a fourth sequence obtained by multiplying [x2, x3, x4, x5, x6, x1] with [1, −1, 1, −1, 1, −1],
a fifth sequence of an inversed version of the fourth sequence, and
a sixth sequence of [x −x, x, −x, x, −x], where x denotes a complex number at a unit circle.

In some embodiments, the one or more OCC sequences with the length of 3 may comprise;
a first sequence of [1, 1, 1],
a second sequence obtained by multiplying [x1, x2, x3], wherein each of x1, x2, and x3 denotes three complex numbers corresponding to three of six points equally dividing a circumference of a unit circle, and
a third sequence of [x3, x2, x1].

In some embodiments, the length of the OCC sequence may be determined based on a size of SRS transmission comb for the terminal device. For example, the length of the OCC sequence is determined as 6 when a size of SRS transmission comb is 2; and/or the length of the OCC sequence is determined as 3 when a size of SRS transmission comb is 4; and/or the length of the OCC sequence is determined as 3 when a size of SRS transmission comb is 8. The size of SRS transmission comb may indicate a density of subcarriers occupied by resource elements for the SRS sequence.

In the process 400, at 402, the terminal device 110 may transmit acknowledge message to the network device 120. By this way, the network device 120 is aware that the terminal device 110 has been successfully configured by the SRS configuration information at 401.

In the process 400, at 403, the terminal device 110 transmits, to the network device 120, a SRS signal using an OCC sequence from the one or more OCC sequences. The terminal device 110 may determine an index of an OCC sequence to use with the SRS signal. In some embodiments, the index of the OCC sequence from the one or more OCC sequences is rotated based on one or more of an index of a timeslot for transmission of the SRS signal or identity of a cell. For example, let occIndex denotes the index, it may be determined based on an equation as below.

occIndex=mod(occOffset-n6-r18+slotIndex,occ sequence length)

where the parameter “occOffset-n6-r18” denotes the above mentioned offset information, the parameter “slotIndex” denotes the index of timeslot, and the parameter “occ sequence length” denotes the length of OCC sequences, which may be 3 or 6.

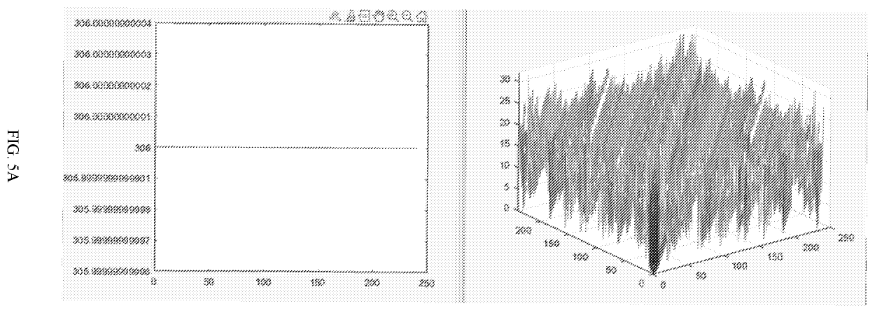

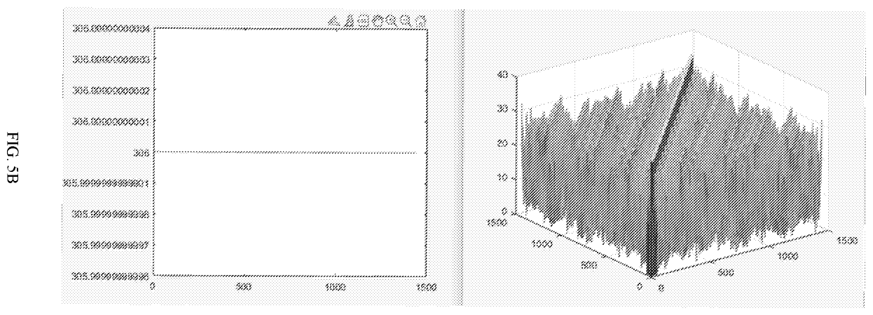

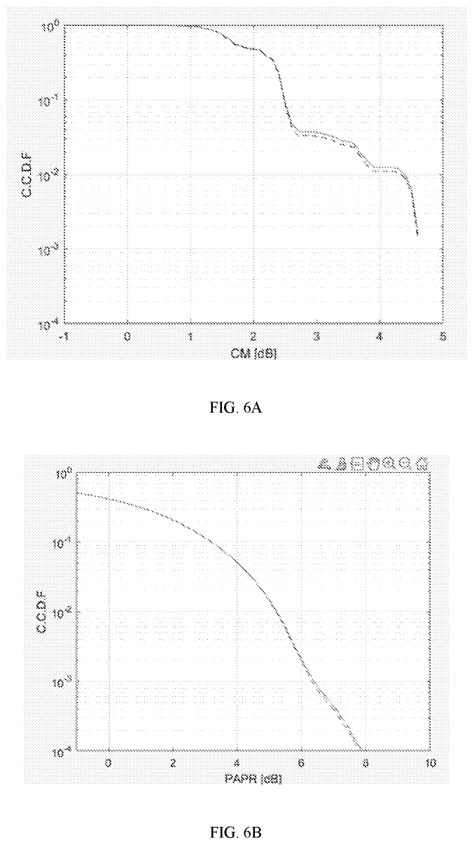

For illustrative purposes, FIG. 5A to FIG. 6 illustrates some simulation results regarding to the solution as proposed herein.

FIG. 5A illustrates correlations of baseline SRS sequences without the OCC sequences as proposed herein for 306 resource length of allocation; and FIG. 5B illustrates correlations of baseline SRS sequences with the OCC sequences as proposed herein for 306 resource length of allocation. In the simulations, there are 30 base sequences with 8 cyclic shifts of baseline setup. Particularly, in each of FIG. 5A and FIG. 5B, a left figure shows correlation of correct codes, and a right figure shows correlations of incorrect sequences. From the simulation results, it is seen that the sequences space may substantially increase, for example, by nearly a factor of 6, when using proposed OCC sequences of length 6, as illustrated by the central dark parts in two right figures in FIG. 5A and FIG. 5B. Meanwhile the proposed OCC sequences may still maintain the good correlations.

FIG. 6A and FIG. 6B respectively illustrate cubic metric (CM) and peak average power ratio (PAPR) for SRS symbol in comparison of prior art configuration and proposed OCC sequences. In FIGS. 6A and 6B, dashed lines represents prior art configuration and solid lines represents proposed OCC sequences. From FIG. 6A and FIG. 6B, it is seen that the solution proposed in the present disclosure may achieve a comparable CM performance and also PAPR while supporting a large number of SRS antenna ports.

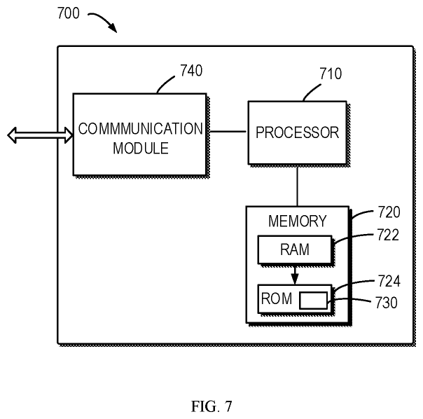

FIG. 7 is a simplified block diagram of a device 700 that is suitable for implementing embodiments of the present disclosure. The device 700 may be provided to implement the communication device, for example the terminal device 110 or the network device 120 as shown in FIG. 1. As shown, the device 700 includes one or more processors 710, one or more memories 740 coupled to the processor 710, and one or more transmitters and/or receivers (TX/RX) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a read only memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program so that the device 700 may perform any process of the disclosure as discussed with reference to FIGS. 2 to 4. The embodiments of the present disclosure may also be implemented by hardware or by a combination of software and hardware.

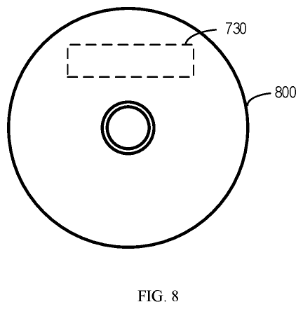

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 200, 300, or process 400 as described above with reference to FIG. 2, FIG. 3 and FIG. 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device, comprising:
at least one processor; and
at least one memory including computer program codes, wherein the at least one memory and the computer program codes are configured to, with the at least one processor, cause the terminal device to:
receive, from a network device, sounding reference signal, SRS, configuration information indicating one or more orthogonal cover code, OCC, sequences in frequency domain, wherein the one or more OCC sequences have a length of one or more of 3 or 6; and
transmit, to the network device, a SRS signal using an OCC sequence from the one or more OCC sequences.

2. The terminal device of claim 1, wherein the SRS configuration information comprises one or more of length information of the one or more OCC sequences and OCC sequence starting information for the one or more OCC sequences.

3. The terminal device of claim 1, wherein the SRS configuration information is comprised in a field in an SRS resource list.

4. The terminal device of claim 1, wherein the SRS configuration information comprises offset information on the one or more OCC sequences for a group of antenna ports, and wherein the OCC sequence from the one or more OCC sequences is determined based on the offset information for the group of antenna ports.

5. The terminal device of claim 1, wherein the one or more OCC sequences with the length of 6 comprise one or more of:
a first sequence of [1, 1, 1, 1, 1, 1];
a second sequence of [x1, x2, x3, x4, x5, x6], wherein x1, x2, x3, x4, x5, and x6 denote six complex numbers corresponding to six points equally dividing a circumference of a unit circle;
a third sequence of [x6, x5, x4, x3, x2, x1];
a fourth sequence obtained by multiplying [x2, x3, x4, x5, x6, x1] with [1, −1, 1, −1, 1, −1];
a fifth sequence of an inversed version of the fourth sequence;
a sixth sequence of [x −x, x, −x, x, −x], where x denotes a complex number at a unit circle.

6. The terminal device of claim 1, wherein the one or more OCC sequences with the length of 3 comprises one or more of:
a first sequence of [1, 1, 1];
a second sequence obtained by multiplying [x1, x2, x3], wherein each of x1, x2, and x3 denotes three complex numbers corresponding to three of six points equally dividing a circumference of a unit circle; and
a third sequence of [x3, x2, x1].

7. The terminal device of claim 1, wherein an index of the OCC sequence from the one or more OCC sequences is rotated based on one or more of an index of a timeslot for transmission of the SRS signal or identity of a cell.

8. The terminal device of claim 1, wherein the length of the OCC sequence is determined based on a size of SRS transmission comb for the terminal device.

9. The terminal device of claim 8, wherein the length of the OCC sequence is determined as 6 when a size of SRS transmission comb is 2; and/or
wherein the length of the OCC sequence is determined as 3 when a size of SRS transmission comb is 4; and/or
wherein the length of the OCC sequence is determined as 3 when a size of SRS transmission comb is 8.

10. The terminal device of claim 8, wherein the size of SRS transmission comb indicates a density of subcarriers occupied by resource elements for the SRS sequence.

11. A network device, comprising:
at least one processor; and
at least one memory including computer program codes, wherein the at least one memory and the computer program codes are configured to, with the at least one processor, cause the network device to:
transmit, to a terminal device, sounding reference signal, SRS, configuration information indicating one or more orthogonal cover code, OCC, sequences in frequency domain, wherein the one or more OCC sequences have a length of one or more of 3 or 6; and
receive, from the terminal device, a SRS signal using an OCC sequence from the one or more OCC sequences.

12. The network device of claim 11, wherein the SRS configuration information comprises one or more of length information of the one or more OCC sequences and OCC sequence starting information for the one or more OCC sequences.

13. The network device of claim 11, wherein the SRS configuration information is comprised in a field in an SRS resource list.

14. The network device of claim 11, wherein the SRS configuration information comprises offset information on the one or more OCC sequences for a group of antenna ports, and wherein the OCC sequence from the one or more OCC sequences is determined based on the offset information for the group of antenna ports.

15. The network device of claim 11, wherein the one or more OCC sequences with the length of 6 comprise one or more of:
a first sequence of [1, 1, 1, 1, 1, 1];
a second sequence of [x1, x2, x3, x4, x5, x6], wherein each x1, x2, x3, x4, x5, x6 denotes six complex numbers corresponding to six points equally dividing a circumference of at a unit circle;
a third sequence of [x6, x5, x4, x3, x2, x1];
a fourth sequence obtained by multiplying [x2, x3, x4, x5, x6, x1] with [1, −1, 1, −1, 1, −1];
a fifth sequence of an inversed version of the fourth sequence;
a sixth sequence of [x −x, x, −x, x, −x], where x denotes a complex number at a unit circle.

16. The network device of claim 11 wherein the one or more OCC sequences with the length of 3 comprises one or more of:
a first sequence of [1, 1, 1];
a second sequence obtained by multiplying [x1, x2, x3], wherein each of x1, x2, and x3 denotes three complex numbers corresponding to three of six points equally dividing a circumference of a unit circle; and
a third sequence of [x3, x2, x1].

17. The network device of claim 11, wherein an index of the OCC sequence from the one or more OCC sequences is rotated based on one or more of an of a timeslot for transmission of the SRS signal or identity of a cell.

18. The network device of claim 11, wherein the length of the OCC sequence is determined based on a size of SRS transmission comb for the terminal device.

19. The network device of claim 18, wherein the length of the OCC sequence is determined as 6 when a size of SRS transmission comb is 2; and/or
wherein the length of the OCC sequence is determined as 3 when a size of SRS transmission comb is 4; and/or
wherein the length of the OCC sequence is determined as 3 when a size of SRS transmission comb is 8.

20. (canceled)

21. A method at a terminal device comprising:
receiving, from a network device, sounding reference signal, SRS, configuration information indicating one or more orthogonal cover code, OCC, sequences in frequency domain, wherein the one or more OCC sequences have a length of one or more of 3 or 6; and
transmitting, to the network device, a SRS signal using an OCC sequence from the one or more OCC sequences.

22-43. (canceled)
